(19) United States
(12) Patent Application Publication
(10) Pub. No.: US 2025/0246922 A1
(43) Pub. Date: Jul. 31, 2025

(54) POWER-CONVERTER CONTROL USING PASS-THROUGH AND SWITCHING MODES

(71) Applicant: Renesas Electronics America Inc., Milpitas, CA (US)

(72) Inventors: Sungkeun LIM, Apex, NC (US); Yen-Mo CHEN, Morrisville, NC (US); Dongwoo HAN, Raleigh, NC (US); Seung Ryul MOON, Apex, NC (US)

(73) Assignee: Renesas Electronics America Inc., Milpitas, CA (US)

(21) Appl. No.: 18/424,001

(22) Filed: Jan. 26, 2024

(51) Int. Cl. H02J 7/00

(52) U.S. Cl. CPC H02J 7/0063; H02J 2207/20

(57) ABSTRACT

Systems and methods for operating a power converter of a device are described. A controller of the power converter may determine a battery voltage of a battery of the device and determine whether the battery voltage meets a threshold voltage. Responsive to determining that the battery voltage meets the threshold voltage, the controller may cause the power converter to operate in a pass-through mode where the power converter provides a load voltage to a load that is equal to the battery voltage. Alternatively, responsive to determining that that battery voltage does not meet the threshold voltage, the controller may cause the power converter to operate in a switching mode where the power converter provides the load voltage that is equal to the threshold voltage. By using the pass-through mode when the battery voltage meets the threshold voltage, a battery life of the device may be conserved.

### BACKGROUND OF THE SPECIFICATION

The present disclosure relates in general to semiconductor devices. More specifically, the present disclosure relates to controlling a power converter to optimize battery life of a device.

Electrical loads are often able to operate with ranges of input voltages (e.g., below nominal input voltages). For example, a heating element may have a nominal input voltage of 4.5 volts but be able to operate with an input voltage that is far less than 4.5 volts (albeit at a lower power). Constantly feeding such loads at the high ends of their operating ranges may provide benefits (e.g., increased heat in the case of a heating element), though it is often at the expense of battery life (e.g., due to switching losses when the input voltages are higher than battery voltages).

### SUMMARY

A method for controlling a power converter is described herein. The method includes determining a battery voltage of a battery of a device and selecting, based on whether the battery voltage meets a threshold voltage, a pass-through mode or a switching (boost) mode for a power converter of the device. The method further includes configuring, based on the selecting, the power converter to operate in the pass-through mode or the switching mode. In the pass-through mode, the power converter is configured to generate a load voltage to a load that is equal to the battery voltage. In the switching mode, the power converter is configured to provide the load voltage that is equal to the threshold voltage.

A semiconductor device is described herein. The semiconductor device comprises a controller configured to determine a battery voltage of a battery of a device and determine whether the battery voltage meets a threshold voltage. Responsive to determining that the battery voltage meets the threshold voltage, the controller is configured to cause a power converter of the device to operate in a pass-through mode where the power converter provides a load voltage to a load that is equal to the battery voltage. Responsive to determining that that battery voltage does not meet the threshold voltage, the controller is configured to cause the power converter to operate in a switching mode where the power converter provides the load voltage that is equal to the threshold voltage.

A system is described herein. The system includes a battery, a load configured to accept a load voltage between a fully-charged-battery voltage and a lower voltage, a power converter connected between the battery and the load, and a controller. The controller is configured to determine a voltage of the battery and determine whether the voltage meets a threshold voltage. Responsive to determining that the voltage meets the threshold voltage, the controller is configured to cause the power converter to operate in a pass-through mode where the power converter provides a load voltage to a load that is equal to the battery voltage. Responsive to determining that that voltage does not meet the threshold voltage, the controller is configured to cause the power converter to operate in a switching mode where the power converter provides the load voltage that is equal to the threshold voltage.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 illustrates an example system configured to implement power-converter control using pass-through and switching modes.

FIG. 2 illustrates an example of the power converter of FIG. 1 implemented as a buck-boost power converter.

FIG. 3 illustrates an example of the power converter of FIG. 1 implemented as a boost power converter.

FIG. 4 illustrates an example of power-converter control using pass-through and switching modes with a threshold voltage equal to a battery threshold voltage.

FIG. 5 illustrates an example flow for implementing power-converter control using pass-through and switching modes.

FIG. 6 illustrates an example method of power-converter control using pass-through and switching modes.

### DETAILED DESCRIPTION

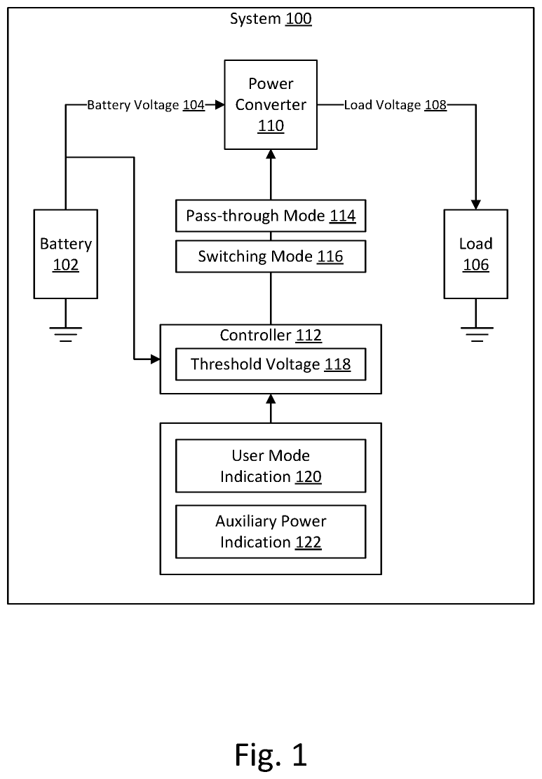

FIG. 1 illustrates an example of a system 100 configured to implement power-converter control using pass-through and switching modes. The system 100 may be comprised by a device (e.g., electronic cigarette, heated object or article, mobile device, any battery powered device with a heater). The system 100 includes a battery 102 configured to supply a battery voltage 104, a load 106 configured to receive a load voltage 108, and a power converter 110 (e.g., buck converter, buck-boost converter, boost converter) configured to convert the battery voltage 104 to the load voltage 108.

The system 100 also includes a controller 112 configured to control the power converter 110 to operate in a pass-through mode 114 (PTM) or a switching mode 116. In the pass-through mode 114, the load voltage 108 output by the power converter 110 is approximately equal to the battery voltage 104 (there may be slight losses through the power converter 110). Further, in the pass-through mode 114, switches in the power converter 110 may not undergo switching. In the switching mode 116, the load voltage 108 output by the power converter 110 may be equal to the threshold voltage 118. Further, in the switching mode 116, switches in the power converter 110 may be switched at specific sequences to regulate the load voltage 108 at the threshold level 118.

The battery 102 may be rechargeable and may have a corresponding fully charged voltage (e.g., corresponding to a full-charge state), a corresponding threshold voltage (e.g., nominal voltage, voltage where the battery voltage 104 begins to quickly degrade while being discharged), and a low voltage (e.g., a lowest battery voltage supplied by the battery 102). For example, the battery 102 may have a fully charged voltage of around 4.2 volts, a threshold/nominal voltage of 3.7 volts, and a low voltage of 2.5 volts to 3 volts.

The load 106 may be any type of electrical component with a variable input voltage. For example, the load 106 may be a heating element configured to operate with an input voltage between 3.7 volts (or below) and 4.5 volts. A higher load voltage 108 will result in more power to the heating element (e.g., faster heating). Conventional techniques often feed such loads at high ends of their input voltage ranges, which requires operating power converters in switching modes throughout the discharge cycles of the batteries (assuming the battery voltages are always lower). This leads to decreased battery life compared to the techniques discussed herein.

To determine whether the power converter 110 should operate in the pass-through mode 114 or the switching mode 116, the controller 112 may compare the battery voltage 104 against a threshold voltage 118. The threshold voltage 118 may be somewhere between the fully charged voltage and the low voltage. For example, the threshold voltage 118 may correspond to the threshold voltage of the battery 102. In some cases, the load 106 may have an input voltage requirement that is higher than the threshold voltage of the battery 102. In those cases, the threshold voltage 118 may be equal to the lowest input voltage accepted by the load 106 (but still less than a fully-charged battery voltage).

In one embodiment, if the battery voltage 104 meets the threshold voltage 118 (e.g., is greater than it, is greater than or equal to it), the controller 112 may control the power converter 110 to operate in the pass-through mode 114. If the battery voltage 104 does not meet the threshold voltage 118 (e.g., is less than it, is less than or equal to it), the controller 112 may control the power converter 110 to operate in the switching mode 116. For a discharge of a battery that starts with a battery voltage 104 above the threshold voltage 118, the controller 112 may control the power converter 110 to operate in the pass-through mode 114 until the battery voltage 104 drops below the threshold voltage 118. From that point until the battery voltage 104 reaches a low-voltage range of the battery 102 (e.g., low voltage range being below threshold voltage 118), the controller 112 may cause the power converter 110 to operate in the switching mode 116. Accordingly, the load voltage 108 supplied to the load 106 may be maintained at threshold voltage 118.

In one embodiment, the controller 112 may use other inputs (e.g., in addition to the battery voltage 104) to determine whether the power converter 110 should operate in the pass-through mode 114 or the switching mode 116. For example, the controller 112 may receive a user-mode indication 120 (e.g., normal mode, battery saving mode) and/or an auxiliary-power indication 122 (e.g., whether the system 100 has auxiliary power, is plugged in). If the user-mode indication 120 indicates a normal mode, then the controller 112 may cause the power converter 110 to operate in the switching mode 116 regardless of the battery voltage 104. Similarly, if the auxiliary-power indication 122 indicates that the system 100 has auxiliary power (e.g., is plugged in, has universal serial bus (USB) power), then the controller 112 may cause the power converter 110 to operate in the switching mode 116 regardless of the battery voltage 104.

In one or more embodiments, the controller 112 may be implemented in software, hardware, or some combination thereof. The controller may be comprised by a semiconductor device (e.g., microcontroller, processor, control unit). Furthermore, the controller 112 may be part of another controller of the device (e.g., central processing unit (CPU), main controller). The controller 112 may be configured to directly control the power converter 110 or control the power converter 110 via drivers (not shown). For example, the controller 112 may be configured to provide control signals (e.g., pulse width modulation (PWM) control signals) to the power converter 110 or to the drivers. The drivers may be part of the power converter or be separate from the power converter 110. The drivers may be configured to receive the control signals from controller 112 and drive switches within the power converter 110.

In one embodiment, the controller 112 may be further configured to execute at least one control loop to determine whether to cause the power converter 110 to operate in the pass-through mode 114 or the switching mode 116 to supply the load voltage 108 to the load 106. In an aspect, a control loop can be implemented by at least one analog and/or digital component of the controller 112 (e.g., software and/or firmware being executed by the controller 112). To execute a control loop, quantitative measurements (e.g., battery voltage 104) can be inputted to a corresponding control loop (along with the user-mode indication 120 and/or the auxiliary-power indication 122 if implemented). The controller 112 can perform comparisons of the quantitative measurements with reference values (e.g., the threshold voltage 118). Results of the comparison may be used by the controller 112 to determine whether to cause the power converter 110 to operate in the pass-through mode 114 or the switching mode 116, as discussed above and below.

In one or more embodiments, the controller 112 may further include components, such as digital to analog converters (DACs), comparators, mixers, memory devices (e.g., registers), and other electronic components. The controller 112 may include memory devices configured to store various predetermined values (e.g., digital representation of the battery voltage 104, digital representation of threshold voltage 118, digital representation of the user mode-indication 120, digital representation of the auxiliary-power indication 122) that can be used by the control loops. For example, registers in the controller 112 can store the predetermined values (e.g., the battery voltage 104), which may then be converted by the DACs in the controller 112 into analog signals. The analog signals can be provided to the control loops as reference values being inputted into the comparators of the controller 112.

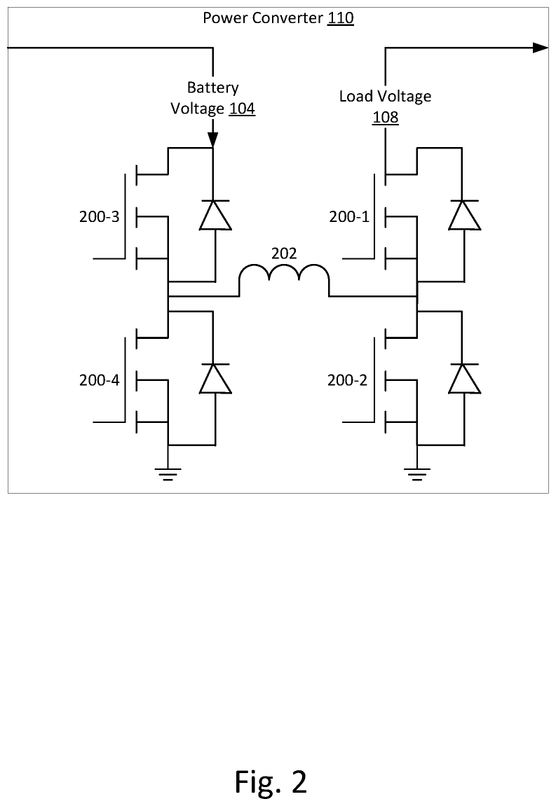

FIG. 2 illustrates an example of the power converter 110 implemented as a buck-boost power converter. The power converter 110 may include a plurality of switches 200 (e.g., 200-1, 200-2, 200-3, and 200-4) and an inductor 202. When the power converter 110 is implemented as a buck-boost power converter, the controller 112 may control the power converter 110 to convert an input voltage (e.g., the battery voltage 104) into an output voltage (e.g., the load voltage 108) that may be less than or greater than the input voltage. The switches 200 may be metal-oxide-semiconductor field-effect transistors (MOSFETs) or other types of switches. The switches 200 are controlled via the controller 112 (either directly or indirectly).

In this configuration, for the pass-through mode 114, the controller 112 may cause switches 200-1 and 200-3 to be in a conductive state and switches 200-2 and 200-4 to be in a non-conductive state. In other words, half of the switches 200 are in the conductive state (that is the high-side switches) and half of the switches 200 are in the non-conductive state (that is the low-side switches). Thus, power flows from the battery voltage 104, through the switch 200-3, the inductor 202, and the switch 200-1, and to the load voltage 108. The pass-through mode 114 may enable the load voltage 108 to be close to the battery voltage 104 without incurring switching losses. The load voltage 108 in this configuration may be expressed as:

$${V}_{load} = {V}_{bat} - {I}_{load} ( D C {R}_{ind} + {R}_{D S , O N , sw 1} + {R}_{D S , ON , sw 3} ) \qquad ( 1 )$$

where V_{load} is the load voltage 108, V_{bat} is the battery voltage 104, I_{load} is a current draw of the load 106, DCR_{ind} is a resistance of the inductor 202, R_{DS,ON,sw1} is a resistance of the switch 200-1 in the conductive state, and R_{DS,ON,sw3} is a resistance of the switch 200-3 in the conductive state.

In this configuration, for the switching mode 116, the controller 112 may control switches 200-1 and 200-2 to switch alternately between conductive and non-conductive states, switch 200-3 to be in the conductive state (e.g., keeping switch 200-3 on), and switch 200-4 to be in the non-conductive state (e.g., keeping switch 200-4 off). Through timing of the switching, the controller 112 may control the power converter 110 to regulate and output the load voltage 108 at the threshold voltage 118.

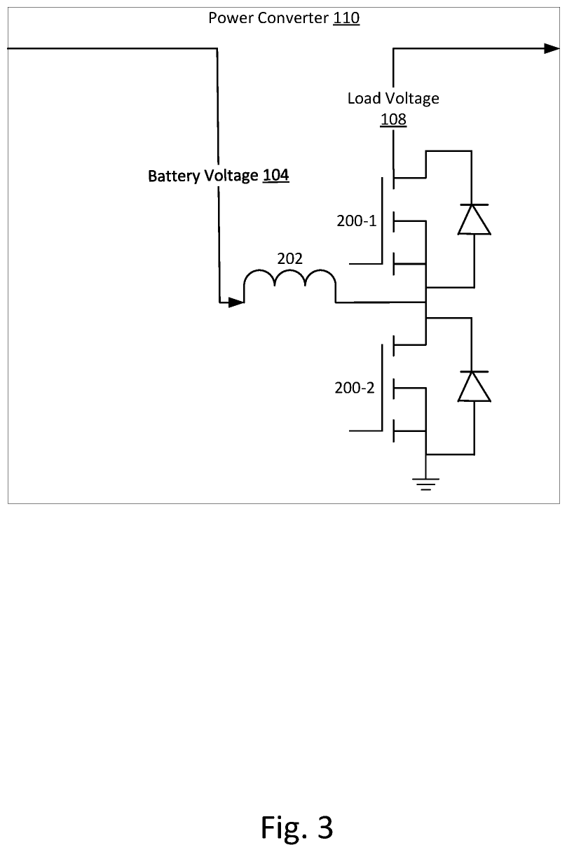

FIG. 3 illustrates an example of the power converter 110 implemented as a boost power converter. When the power converter 110 is implemented as a boost power converter, the controller 112 may control the power converter 110 to convert an input voltage (e.g., the battery voltage 104) into an output voltage (e.g., the load voltage 108) that may be greater than the input voltage.

In this configuration, for the pass-through mode 114, the controller 112 may cause switch 200-1 to be in a conductive state and switch 200-2 to be in a non-conductive state. In other words, half of the switches 200 are in the conductive state (that is the high-side switch) and half of the switches 200 are in the non-conductive state (that is the low-side switch). Thus, power flows from the battery voltage 104, through the inductor 202 and the switch 200-1, and to the load voltage 108. Doing so enables the load voltage 108 to be close to the battery voltage 104 without incurring switching losses. The load voltage 108 in this configuration can be expressed as:

$${V}_{load} = {V}_{bat} - {I}_{load} ( D C {R}_{ind} + {R}_{D S , ON , sw 1} ) \qquad ( 2 )$$

In this configuration, for the switching mode 116, the controller 112 may control switches 200-1 and 200-2 to switch alternately between conductive and non-conductive states. Through timing of the switching, the controller 112 may control the power converter 110 to regulate and output the load voltage 108 at the threshold voltage 118.

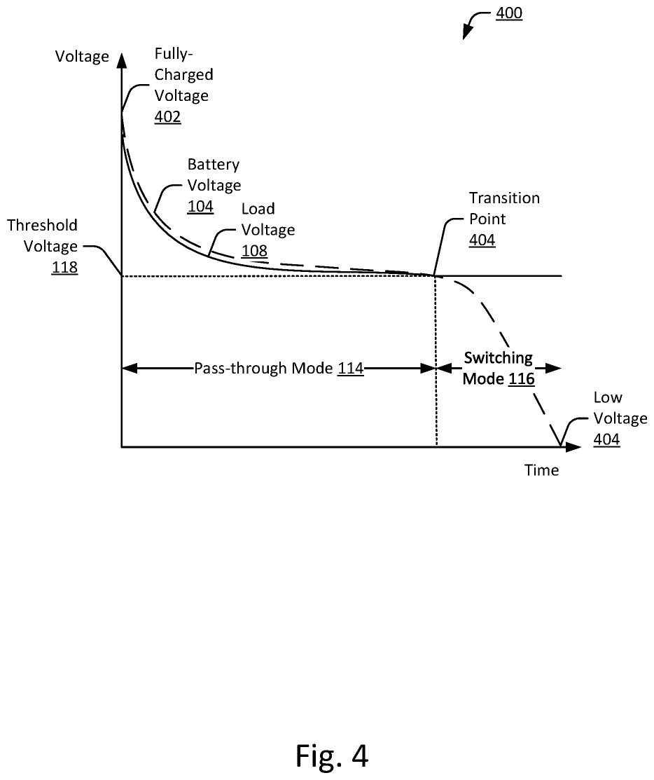

FIG. 4 illustrates, at 400, example voltages as the battery 102 discharges over time (assuming no auxiliary power is added) using pass-through and switching modes. In the illustrated example, the battery voltage 104 begins at a fully charged voltage 402 (e.g., 4.2 volts, the maximum voltage for a 1-cell li-ion battery) and the threshold voltage 118 is at the nominal or threshold voltage for the battery 102 (e.g., 3.7 volts, a nominal voltage for a 1-cell li-ion battery).

At the start, the battery voltage 104 is above/meets the threshold voltage 118, thus, the controller 112 may control the power converter 110 to operate in the pass-through mode 114. As discussed above, the load voltage 108 in the pass-through mode 114 is slightly below the battery voltage 104 as the battery discharges from the fully charged voltage 402.

The controller continues to operate the power converter 110 in the pass-through mode 114 until the battery voltage 104 meets or drops below the threshold voltage (e.g., at transition point 404). At that point, since the battery voltage 104 is not above/does not meet the threshold voltage 118, the controller 112 may control the power converter 110 to switch to the switching mode 116. As discussed above, the power converter 110 produces the load voltage 108 at the threshold voltage 118 in the switching mode.

In the illustrated example, it is clear that the power converter 110 operates in the pass-through mode 114 for a majority of the discharge cycle. Because the pass-through mode 114 does not incur switching losses, battery life can be improved relative to constantly operating the power converter 110 in the switching mode 116 (e.g., to produce the load voltage 108 at a voltage higher than that of the fully charged voltage 402).

In some implementations, a lower bound for the load voltage 108 may be higher than the threshold voltage of the battery 102. For example, the load 106 may be able to accept a load voltage 108 of 3.9 volts in a system with a battery threshold of 3.7 volts. In this case, the threshold voltage 118 may be set to the minimum load voltage. The transition point 404 would be further to the left along the battery voltage 104 curve, but the advantages may still be realized (albeit with less energy savings due to a shorter time in the pass-through mode 114.

Conversely, a lower bound for the load voltage 108 may be lower than the threshold voltage of the battery 102. For example, the load 106 may be able to accept a load voltage 108 of 2 volts for a 3.7 volt battery. In this case, the threshold voltage 118 could be set to the minimum load voltage (e.g., push the transition point 404 along the battery voltage 104 curve to the right). While this may lead to increased energy savings by having the power converter 110 operate in the pass-through mode 114 longer, it may come at the expense of performance of the load 106 (e.g., unacceptable heating time in the case of a heater).

Accordingly, the threshold voltage 118 may be set according to a variety of factors (e.g., desired energy savings, desired minimum load voltage, type of load). For applications where a higher load voltage 108 is generally desirable (e.g., an intermittent heater), the battery threshold may constitute a good value for the threshold voltage 118. This is because the majority of a discharge cycle may be spent in the pass-through mode 114 while still achieving relatively high load voltages.

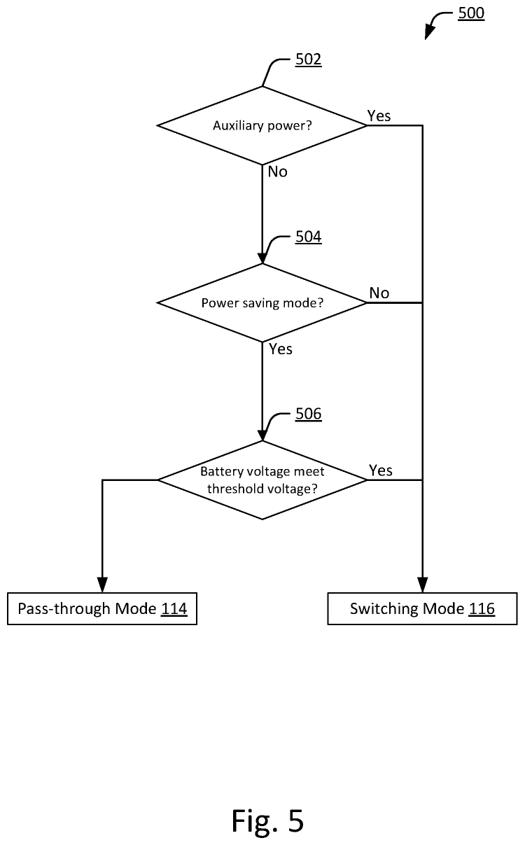

FIG. 5 illustrates an example logic flow 500 for implementing power-converter control using pass-through and switching modes. The example logic flow 500 may be implemented by the controller 112. Example logic flow 500 can include one or more operations, actions, or functions as illustrated by one or more of blocks 502, 504, and/or 506. Although illustrated as discrete blocks, various blocks may be divided into additional blocks, combined into fewer blocks, eliminated, performed in different order, or performed in parallel, depending on the desired implementation.

Optionally, at decision 502, it may be determined whether there is auxiliary power to a device. For example, it may be determined whether the auxiliary-power indication 122 indicates an external source of power is connected to the system 100 (e.g., other than the battery 102). If an external source of power is connected (e.g., a “yes” out of decision 502), then the power converter 110 may be operated in the switching mode 116. If an external source of power is not connected (e.g., a “no” out of decision 502), then the example logic flow 500 may continue to decision 504.

Optionally, at decision 504, it may be determined whether the device is in a power-saving mode. For example, it may be determined whether the user-mode indication 120 indicates that the system 100 is to be operated in a power-saving mode. If it is determined that the system 100 is not to be operated in the power-saving mode (e.g., a normal mode or a “no” out of decision 504), then the power converter 110 may be operated in the switching mode 116. If it is determined that the system 100 is to be operated in the power-saving mode (e.g., a “yes” out of decision 504), then the example logic flow 500 may continue to decision 506.

At decision 506, it may be determined whether a battery voltage meets a threshold voltage. For example, it may be determined whether the battery voltage 104 meets the threshold voltage 118. If the battery voltage 104 meets the threshold voltage 118 (e.g., is greater than or greater than or equal to it), then the power converter 110 may be operated in the pass-through mode 114. If the battery voltage 104 does not meet the threshold voltage 118 (e.g., is less than or less than or equal to it), then the power converter 110 may be operated in the switching mode 116.

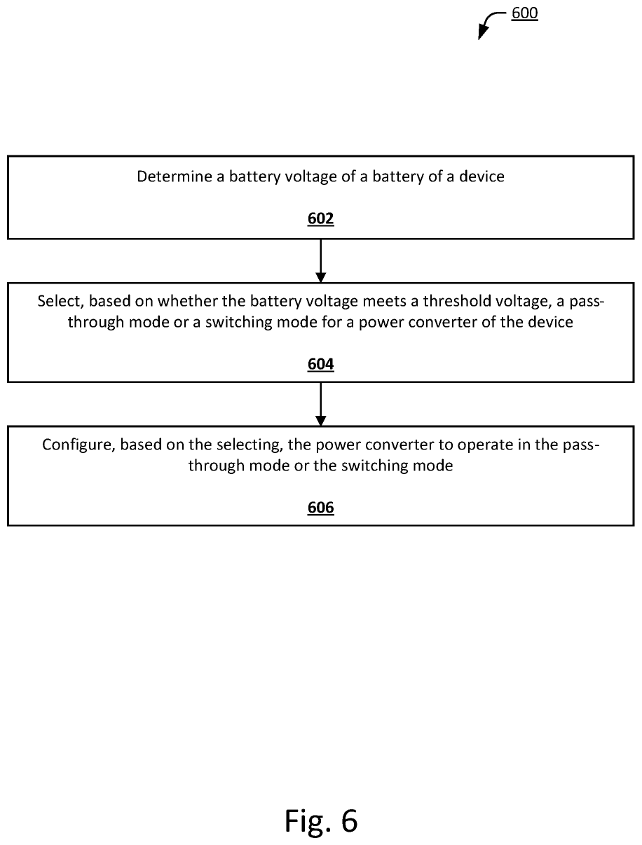

FIG. 6 illustrates an example method 600 for implementing power-converter control using pass-through and switching modes. The example method 600 may be implemented by the controller 112. Example method 600 can include one or more operations, actions, or functions as illustrated by one or more of blocks 602, 604, and/or 606. Although illustrated as discrete blocks, various blocks may be divided into additional blocks, combined into fewer blocks, eliminated, performed in different order, or performed in parallel, depending on the desired implementation.

At 602, a battery voltage of a battery of a device is determined. For example, the controller 112 may determine the battery voltage 104.

At 604, a pass-through mode or a switching mode for a power converter of the device is selected based on whether the battery voltage meets a threshold voltage. For example, the controller 112 may compare the battery voltage 104 to the threshold voltage 118. If the battery voltage 104 meets the threshold voltage 118 (e.g., is greater than or greater than or equal to the threshold voltage 118), the controller 112 may select the pass-through mode 114. Conversely, if the battery voltage 104 does not meet the threshold voltage 118 (e.g., is less than or less than or equal to the threshold voltage 118), the controller 112 may select the switching mode 116.

At 606, the power converter is configured to operate in the pass-through mode or the switching mode based on the selecting. For example, the controller 112 may cause the power converter 110 to operate in the pass-through mode 114 or the switching mode 116 by configuring (or causing the configuration of) the switches 200 to operate as discussed above.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method comprising:
determining a battery voltage of a battery of a device;
selecting, based on whether the battery voltage meets a threshold voltage, a pass-through mode or a switching mode for a power converter of the device; and
configuring, based on the selecting, the power converter to operate in the pass-through mode or the switching mode, wherein:
in the pass-through mode, the power converter is configured to generate a load voltage to a load that is equal to the battery voltage, and
in the switching mode, the power converter is configured to provide the load voltage that is equal to the threshold voltage.

2. The method of claim 1, wherein the threshold voltage corresponds to a nominal voltage of the battery.

3. The method of claim 1, wherein the method is performed responsive to determining that the device is to be operated in a power-saving mode.

4. The method of claim 1, wherein the power converter is a buck-boost power converter.

5. The method of claim 1, wherein the power converter is a boost power converter.

6. The method of claim 1, wherein the selecting comprises selecting the pass-through mode responsive to determining that the battery voltage meets the threshold voltage.

7. The method of claim 1, wherein the selecting comprises selecting the switching mode responsive to determining that the battery voltage does not meet the threshold voltage.

8. The method of claim 1, wherein in the pass-through mode, at least one high-side switch in the power converter remains turned on and at least one low-side switch in the power converter remains turned off.

9. The method of claim 1, wherein the load comprises a heating element.

10. The method of claim 1, wherein the load is configured to accept load voltages ranging from a fully-charged voltage corresponding to a full-charge state of the battery to at least the threshold voltage.

11. A semiconductor device comprising:
a controller configured to:
determine a battery voltage of a battery of a device;
determine whether the battery voltage meets a threshold voltage; and
responsive to determining that the battery voltage meets the threshold voltage, cause a power converter of the device to operate in a pass-through mode where the power converter provides a load voltage to a load that is equal to the battery voltage; or
responsive to determining that that battery voltage does not meet the threshold voltage, cause the power converter to operate in a switching mode where the power converter provides the load voltage that is equal to the threshold voltage.

12. The controller of claim 11, wherein the controller is further configured to:
determine whether the device is to be operated in a normal or a power-saving mode; and
responsive to determining that the device is to be operated in the normal mode, cause the power converter of the device to operate in the switching mode.

13. The controller of claim 11, wherein the threshold voltage corresponds to a nominal voltage of the battery.

14. The controller of claim 11, wherein the power converter is a buck-boost power converter.

15. The controller of claim 11, wherein the power converter is a boost power converter.

16. The controller of claim 11, wherein the causing the power converter to operate in the pass-through mode or the switching mode comprises configuring operation of two or four switches of the power converter.

17. The controller of claim 11, wherein the load is configured to accept load voltages ranging from a fully-charged voltage to at least the threshold voltage.

18. A system comprising:
a battery;
a load configured to accept a load voltage between a fully-charged-battery voltage and a lower voltage;
a power converter connected between the battery and the load; and
a controller configured to:
determine a voltage of the battery;
determine whether the voltage meets a threshold voltage; and
responsive to determining that the voltage meets the threshold voltage, cause the power converter to operate in a pass-through mode where the power converter provides the load voltage to the load that is equal to the battery voltage; or
responsive to determining that that the voltage does not meet the threshold voltage, cause the power converter to operate in a switching mode where the power converter provides the load voltage that is equal to the threshold voltage.

19. The system of claim 18, wherein:
the power converter comprises a plurality of switches; and
one or more high-side switches in the power converter are maintained in a conductive state in the pass-through mode.

20. The system of claim 18, wherein the threshold voltage corresponds to the lower voltage.
